(19) United States
(12) Patent Application Publication
(10) Pub. No.: US 2017/0094105 A1
(43) Pub. Date: Mar. 30, 2017

(54) IMAGE PROCESSING APPARATUS, IMAGE PROCESSING SYSTEM, IMAGE PROCESSING METHOD, AND NON-TRANSITORY COMPUTER READABLE MEDIUM

(71) Applicant: FUJI XEROX CO., LTD., Tokyo (JP)

(72) Inventor: Kazuhiro OHKAWA, Kanagawa (JP)

(73) Assignee: FUJI XEROX CO., LTD., Tokyo (JP)

(21) Appl. No.: 15/042,759

(22) Filed: Feb. 12, 2016

(30) Foreign Application Priority Data
Sep. 24, 2015 (JP) 2015-186493

(51) Int. Cl. H04N 1/32; H04N 1/00

(52) U.S. Cl. CPC H04N 1/32683; H04N 1/0097; H04N 1/00037; H04N 1/00084; H04N 1/32625; H04N 1/32694; H04N 2201/0094

(57) ABSTRACT

An image processing apparatus includes a processing unit, a storing unit, a detecting unit, and a controller. The processing unit processes a processing target of image processing in accordance with image processing setting for the processing target and an image processing program. The storing unit stores at least one occurrence condition for a failure at the processing unit. The detecting unit detects, in accordance with a detection program, whether or not the processing target or the setting satisfies the occurrence condition for the failure. The controller performs control for presenting information for avoiding the failure or control for avoiding the failure when the detecting unit detects that the occurrence condition for the failure is satisfied.

### CROSS-REFERENCE TO RELATED APPLICATIONS

This application is based on and claims priority under 35 USC 119 from Japanese Patent Application No. 2015-186493 filed Sep. 24, 2015.

### BACKGROUND

(i) Technical Field

The present invention relates to an image processing apparatus, an image processing system, an image processing method, and a non-transitory computer readable medium.

(ii) Related Art

In order to perform processing for detecting occurrence of a failure and the type of the failure and avoiding the failure, there is a need to identify a factor of the failure and an avoidance or resolution method and then correct a version of an image processing program, and the contents of image processing need to be corrected. However, some users may emphasize the operation history and continue to use an old version of the image processing program without updating the image processing program.

Users who continue to use an old version of an image processing program without updating the image processing program fail to avoid a failure for which a condition and an avoidance or resolution method are identified, and a defect occurs.

### SUMMARY

According to an aspect of the invention, there is provided an image processing apparatus including a processing unit, a storing unit, a detecting unit, and a controller. The processing unit processes a processing target of image processing in accordance with image processing setting for the processing target and an image processing program. The storing unit stores at least one occurrence condition for a failure at the processing unit. The detecting unit detects, in accordance with a detection program, whether or not the processing target or the setting satisfies the occurrence condition for the failure. The controller performs control for presenting information for avoiding the failure or control for avoiding the failure when the detecting unit detects that the occurrence condition for the failure is satisfied.

### BRIEF DESCRIPTION OF THE DRAWINGS

Exemplary embodiments of the present invention will be described in detail based on the following figures, wherein:

FIG. 1 is a conceptual module configuration diagram of a configuration example according to a first exemplary embodiment;

FIG. 2 is an explanatory diagram illustrating a system configuration example according to an exemplary embodiment;

FIG. 3 is an explanatory diagram illustrating a data configuration example of a failure table;

FIG. 4 is an explanatory diagram illustrating an example of a data structure of a job attribute management table;

FIG. 5 is an explanatory diagram illustrating an example of a data structure of a job attribute management (in process) table;

FIG. 6 is a flowchart illustrating a processing example according to the first exemplary embodiment;

FIG. 7 is a conceptual module configuration diagram of a configuration example according to a second exemplary embodiment;

FIG. 8 is a flowchart illustrating a processing example according to the second exemplary embodiment;

FIG. 9 is a conceptual module configuration diagram of a configuration example according to a third exemplary embodiment;

FIG. 10 is a flowchart illustrating a processing example according to the third exemplary embodiment; and

FIG. 11 is a block diagram illustrating an example of a hardware configuration of a computer according to an exemplary embodiment.

### DETAILED DESCRIPTION

First, before explanation for exemplary embodiments is provided, preconditions will be explained. The explanation provided below is given for easier understanding of exemplary embodiments.

When a user does not update a program for image processing and image generation, even if countermeasures against a failure have been taken, the user encounters the failure. Furthermore, failures are often caused by setting of a job or description of a page description language (PDL), and therefore may be avoidable by changing settings or changing PDL description.

In exemplary embodiments, a failure may be avoidable even under an environment managed by such a user (an environment in which an old version is maintained).

To this end, a job management program, which is to be updated in association with coping with a failure, and a program for image processing and generation are provided separately, and a job management module 120 detects in advance a failure that is to occur in a program of an old version. Methods for notifying a user of a detection result include “presentation of an occurrence condition”, “presentation of an avoidance method” (including “presentation of a version with which avoidance is possible”), “tentative provision of a program of a version with which avoidance is possible”, and “changing of a job order”. The above methods are merely an example list and other types of information may be presented. Furthermore, one or a combination of the above methods may be presented.

Hereinafter, exemplary embodiments of the present invention will be described with reference to the drawings.

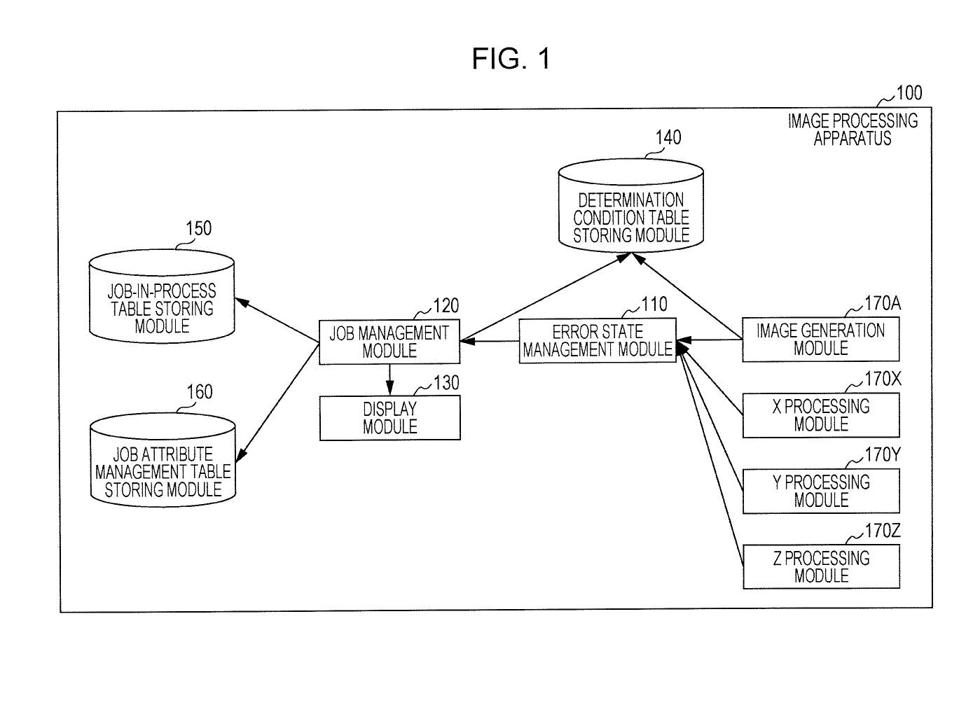

FIG. 1 is a conceptual module configuration diagram of a configuration example according to a first exemplary embodiment.

In general, the term “module” refers to a component such as software (a computer program), hardware, or the like, which may be logically separated. Therefore, a module in an exemplary embodiment refers not only to a module in a computer program but also to a module in a hardware configuration. Accordingly, through an exemplary embodiment, a computer program for causing the component to function as a module (a program for causing a computer to perform each step, a program for causing a computer to function as each unit, and a program for causing a computer to perform each function), a system, and a method are described. However, for convenience of description, the terms “store”, “cause something to store”, and other equivalent expressions will be used. When an exemplary embodiment relates to a computer program, the terms and expressions represent “causing a storage device to store”, or “controlling a storage device to store”. A module and a function may be associated on a one-to-one basis. In the actual implementation, however, one module may be implemented by one program, multiple modules may be implemented by one program, or one module may be implemented by multiple programs. Furthermore, multiple modules may be executed by one computer, or one module may be executed by multiple computers in a distributed computer environment or a parallel computer environment. Moreover, a module may include another module. In addition, hereinafter, the term “connection” may refer to logical connection (such as data transfer, instruction, and cross-reference relationship between data) as well as physical connection. The term “being predetermined” represents being set prior to target processing being performed. “Being predetermined” represents not only being set prior to processing in an exemplary embodiment but also being set even after the processing in the exemplary embodiment has started, in accordance with the condition and state at that time or in accordance with the condition and state during a period up to that time, as long as being set prior to the target processing being performed. When there are plural “predetermined values”, the values may be different from one another, or two or more values (obviously, including all the values) may be the same. The term “in the case of A, B is performed” represents “a determination as to whether it is A or not is performed, and when it is determined to be A, B is performed”, unless the determination of whether it is A or not is not required.

Moreover, a “system” or a “device” may be implemented not only by multiple computers, hardware, devices, or the like connected through a communication unit such as a network (including a one-to-one communication connection), but also by a single computer, hardware, device, or the like. The terms “device” and “system” are used as synonymous terms. Obviously, the term “system” does not include social “mechanisms” (social system), which are only artificially arranged.

Furthermore, for each process in a module or for individual processes in a module performing plural processes, target information is read from a storage device and a processing result is written to the storage device after the process is performed. Therefore, the description of reading from the storage device before the process is performed or the description of writing to the storage device after the process is performed may be omitted. The storage device may be a hard disk, a random access memory (RAM), an external storage medium, a storage device using a communication line, a register within a central processing unit (CPU), or the like.

An image processing apparatus 100 according to a first exemplary embodiment is an apparatus which performs processing such as printing of images and provides, in particular, a function of avoiding a known failure at the image processing apparatus 100. As illustrated in an example of FIG. 1, the image processing apparatus 100 includes an error state management module 110, the job management module 120, a display module 130, a determination condition table storing module 140, a job-in-process table storing module 150, a job attribute management table storing module 160, an image generation module 170A, an X processing module 170X, a Y processing module 170Y, and a Z processing module 170Z. As processing units, for example, the image generation module 170A, the X processing module 170X, the Y processing module 170Y, and the Z processing module 170Z may be used. As a storing unit, for example, the determination condition table storing module 140 may be used. As a detecting unit, for example, the error state management module 110 and the job management module 120 may be used. As a controller, for example, the job management module 120 and the display module 130 may be used. The image processing apparatus 100 is, for example, a multifunction machine (an image processing apparatus having two or more of functions of a scanner, a printer, a copying machine, a facsimile machine, and the like), a copying machine, a facsimile machine, a scanner, a printer, or the like. The image processing apparatus 100 performs processing in accordance with a job. A job is an execution request for the image processing apparatus 100. Jobs include, for example, an original document copying job, a printing job, an image reading job, a facsimile transmission/reception job, and the like. A failure mentioned herein is caused by a job setting or contents of job data for the case where a specific job setting is done, the case where a PDL to be processed includes a specific description, or other cases. The failure is a defect which is reproducible, occurrence of the defect being predictable by a job setting or contents of job data, and an avoidance or resolution method for the defect has been identified. Defects include an error which is explicitly displayed, such as a state in which a job does not end normally, and a phenomena which is not explicitly displayed, such as a state in which the quality of printing is defective.

In the description provided below, all the states which are explicitly displayed as error are will be referred to as an “error”, and defective quality and the like which are not explicitly displayed as error will be referred to as a “defect”. Among defects, a defect “which is reproducible, a cause such as an occurrence condition and an avoidance or resolution method of the defect being identified, and which may be predicted by a job setting or job data” and for which a condition, an avoidance measure, and the like are stored, will be referred to as a “failure”.

In an exemplary embodiment described below, an image processing/image generation program (a program operating at the image generation module 170A, the X processing module 170X, the Y processing module 170Y, and the Z processing module 170Z) and a program which provides presentation of a failure and executes changing of the order of jobs and temporary stop (a program operating at the job management module 120) are provided separately. Therefore, the image processing/image generation program and the program for avoiding a failure caused by the image processing/image generation program may be separately provided and updated independently.

A user may emphasize the operation history of the image processing/image generation program and use an old version. However, a program which presents occurrence of an error, which is not directly relevant to image processing/image generation, is often updated. Therefore, by presentation to the user who uses the old version, an avoidance method or the like may be provided.

That is, a program which operates by a program operating at the image generation module 170A, the X processing module 170X, the Y processing module 170Y, and the Z processing module 170Z differs from a program operating at the job management module 120. Accordingly, version upgrade of these programs may be attained independently.

In addition, even in the case where a user does not upgrade the program for image processing/image generation operating at the image generation module 170A, the X processing module 170X, the Y processing module 170Y, and the Z processing module 170Z (version upgrade is not permitted by a user), the program for the job management module 120 for controlling presentation of occurrence of a failure, changing of the order of jobs, and temporary stop may be upgraded.

The image generation module 170A, the X processing module 170X, the Y processing module 170Y, and the Z processing module 170Z process a processing target of image processing in accordance with image processing settings for the processing target and an image processing program. Specific examples will be provided below.

The image generation module 170A is connected to the error state management module 110 and the determination condition table storing module 140. The image generation module 170A generates image data which may be printed from received PDL data or the like to be printed.

The X processing module 170X, the Y processing module 170Y, and the Z processing module 170Z are connected to the error state management module 110. These modules perform processing of the functions provided by the image processing apparatus 100. For example, the X processing module 170X, the Y processing module 170Y, and the Z processing module 170Z may perform image reading processing, communicate with a different information processing apparatus, or perform post-processing (stapling, hole making, or the like) on printed paper.

When an error occurs at the image generation module 170A, the X processing module 170X, the Y processing module 170Y, or the Z processing module 170Z, the error state management module 110 is notified of the occurrence of the error. Furthermore, based on a result of analysis of job data, when an occurrence condition for a failure in the determination condition table storing module 140 is satisfied, the image generation module 170A notifies the job management module 120 of “determination condition satisfied” (that is, a failure).

The error state management module 110 is connected to the job management module 120, the image generation module 170A, the X processing module 170X, the Y processing module 170Y, and the Z processing module 170Z. The error state management module 110 detects, based on a detection program, whether or not a processing target or a setting satisfies an occurrence condition for a failure. Furthermore, the error state management module 110 receives a notification of occurrence of an error or the like (to be precise, a failure which is reported as an error from the image generation module 170A, and hereinafter, may be referred to as an error or the like) from the image generation module 170A, the X processing module 170X, the Y processing module 170Y, or the Z processing module 170Z. Then, the error state management module 110 notifies the job management module 120 of contents of the error or the like and the module at which the error or the like has occurred.

The job management module 120 is connected to the error state management module 110, the display module 130, the determination condition table storing module 140, the job-in-process table storing module 150, and the job attribute management table storing module 160. When the error state management module 110 detects that an occurrence condition for a failure is satisfied, the job management module 120 performs control for presenting information for avoiding the failure or control for avoiding the failure. Information for avoiding a failure may be, for example, an occurrence condition for the failure. This is because only presenting an occurrence condition for a failure may allow a user to eliminate the condition. Furthermore, it may be detected whether or not an occurrence condition for a failure at the image generation module 170A, the X processing module 170X, the Y processing module 170Y, or the Z processing module 170Z is satisfied. A timing of detection may be a time at which (or before) processing starts or after the processing starts as long as it is before the error state management module 110 detects an error (before the actual error occurs). The display module 130 is controlled such that an avoidance method for the failure which corresponds to the occurrence condition for the failure detected by the error state management module 110 may be presented using the determination condition table storing module 140. That is, in an exemplary embodiment, occurrence of a failure is predicted based on the occurrence condition for the failure which is stored before an error occurs, and an avoidance method is presented based on an avoidance method for the failure which is stored in association with the prediction. Therefore, detection of whether or not a job setting or PDL description satisfies an occurrence condition for the failure is performed before the error is detected.

Furthermore, the job management module 120 may control the display module 130 such that information for avoiding the failure or an occurrence condition for the failure and an avoidance method for the failure may be presented. The job management module 120 may control the display module 130 such that a version of a program in which the failure has been removed may be presented as an avoidance method for the failure. The job management module 120 may control the display module 130 such that an avoidance method corresponding to an occurrence condition for the failure in the determination condition table storing module 140 and a version of an image processing program in which the failure has been removed may be presented.

The display module 130 is connected to the job management module 120. The display module 130 presents an avoidance method for a failure to a presentation device of the image processing apparatus 100, under the control by the job management module 120. “Presentation” may be one or a combination of display on a display device such as a liquid crystal display, printing at a printer, output of sound to a sound output device such as a speaker, and the like.

Furthermore, the display module 130 may present an avoidance method and a version of an image processing program in which the failure has been removed to the presentation device of the image processing apparatus 100, under the control by the job management module 120.

The determination condition table storing module 140 is connected to the job management module 120 and the image generation module 170A. The determination condition table storing module 140 stores occurrence conditions for a failure at the image generation module 170A, the X processing module 170X, the Y processing module 170Y, and the Z processing module 170Z. The determination condition table storing module 140 may store an occurrence condition for a failure in image generation processing at the image processing apparatus 100 or the image generation module 170A and an avoidance method for the failure in association with each other. Furthermore, the determination condition table storing module 140 may store a version of an image processing program in which the failure has been removed and an occurrence condition for the failure in association with each other.

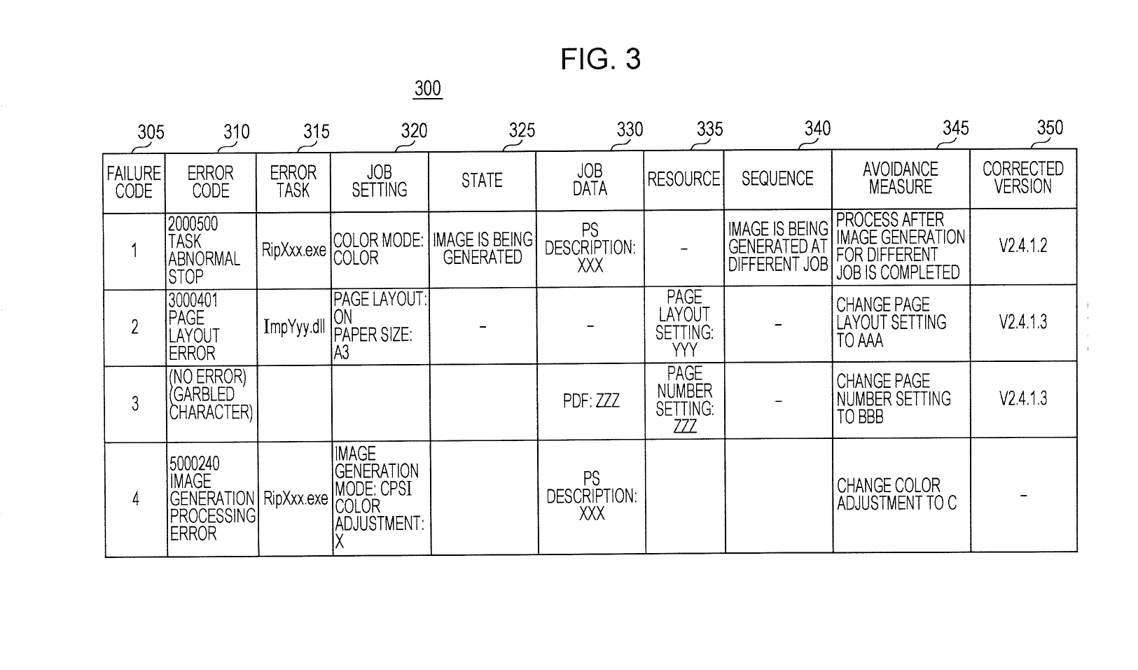

Specifically, the determination condition table storing module 140 stores an error code, an error occurrence point (error task), a job setting, job data (PDL description), a resource, a job state at the time of occurrence of an error, a sequence (processing order and the state of other jobs, and the like. The determination condition table storing module 140 also stores information regarding avoidance of the failure. Specifically, an avoidance measure/corrected version (correction patch) is stored. More specifically, the determination condition table storing module 140 stores a failure table 300. FIG. 3 is an explanatory diagram illustrating an example of the data structure of the failure table 300. The failure table 300 includes a failure code field 305, an error code field 310, an error task field 315, a job setting field 320, a state field 325, a job data field 330, a resource field 335, a sequence field 340, an avoidance measure field 345, and a corrected version field 350. The failure code field 305 stores information (failure code) for uniquely identifying a failure in an exemplary embodiment. The error code field 310 stores an error code which is a target of the failure. The error task field 315 stores an error task which is a target of the failure. The error task represents a task at which the error has occurred (part or all of an image processing program). The job setting field 320 stores job setting in which the failure occurs. For example, job settings include a color mode (a processing system for determining whether printing is to be done in color or black and white), page layout (the number of pages to be printed in a single sheet of paper), paper size, a processing system used for image generation (for example, configurable postscript interpreter (CPSI) or the like), color adjustment, and the like. The state field 325 stores a state in which the failure occurs. For example, a state may be “image is being generated”. The job data field 330 stores job data in which the failure occurs. For example, job data may be description contents of postscript or PDF. The resource field 335 stores a resource in which the failure occurs. For example, a resource may be setting of page layout, setting of a page number, or the like. The sequence field 340 stores a sequence in which the failure occurs. That is, a processing order for the case where the failure occurs or a state of other processing is stored. The avoidance measure field 345 stores an avoidance measure against the failure. When a condition is satisfied, the avoidance measure may be automatically applied or a determination as to whether or not to apply the avoidance measure may be made based on an operation by an operator. This is because, for example, an operator may permit the failure (for example, changing of color tone or the like). The corrected version field 350 stores a corrected version of the failure (a version of an image processing program in which the failure has been removed).

A failure code: 3 which is illustrated in the example of FIG. 3 represents a case where printing is completed without an explicit error occurring but there is a problem (garbled character) in a printing result, and the error code field 310 is empty. That is, this case does not correspond to an “error” but corresponds to a “failure”.

A failure code: 4 which is illustrated in the example of FIG. 3 represents a case where the corrected version field 350 is empty since correction of a failure is not performed but an avoidance measure in the avoidance measure field 345 is clear.

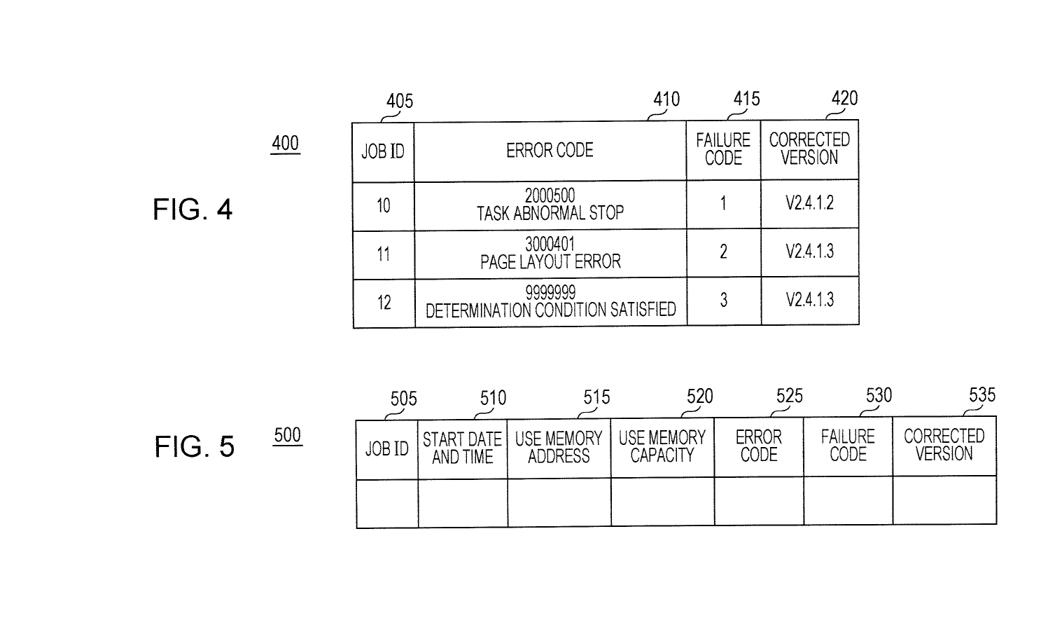

The job attribute management table storing module 160 is connected to the job management module 120. The job attribute management table storing module 160 stores information of a job (for example, may include attributes and the like). For example, a job attribute management table 400 is stored. FIG. 4 is an explanatory diagram illustrating an example of the data structure of the job attribute management table 400. The job attribute management table 400 includes a job ID field 405, an error code field 410, a failure code field 415, and a corrected version field 420. The job ID field 405 stores information (job identification (ID)) for uniquely identifying a job in an exemplary embodiment. The error code field 410 stores an error code of an error which has occurred at the job. The failure code field 415 stores a failure code of a failure which has occurred at the job. The corrected version field 420 stores a corrected version of an image processing program in which the failure has been removed.

The job-in-process table storing module 150 is connected to the job management module 120. The job-in-process table storing module 150 stores information of a job which is being processed. The job-in-process table storing module 150 stores, for example, a job attribute management (in-process) table 500. FIG. 5 is an explanatory diagram illustrating an example of the data structure of the job attribute management (in-process) table 500. The job attribute management (in-process) table 500 includes a job ID field 505, a start date and time field 510, a use memory address field 515, a use memory capacity field 520, an error code field 525, a failure code field 530, and a corrected version field 535. The job ID field 505 stores a job ID. The start date and time field 510 stores a start date and time (year, month, date, hours, minutes, seconds, a unit smaller than seconds, or a combination of some of them) of processing of the job. The use memory address field 515 stores a memory address used by the job. The use memory capacity field 520 stores a memory capacity used by the job. The error code field 525 stores an error code of an error which has occurred at the job. The failure code field 530 stores a failure code of a failure which has occurred at the job. The corrected version field 535 stores a corrected version of an image processing program in which the failure has been removed.

Only one of the job-in-process table storing module 150 and the job attribute management table storing module 160 may be provided. However, a field may be added to the job attribute management table 400 or the job attribute management (in-process) table 500 so that a flag indicating whether or not a job is being processed (whether or not processing is finished) may be stored.

The overview of a process of the image processing apparatus 100 will be described below.

In Step 102, when an error occurs, each of the processing modules (the image generation module 170A, the X processing module 170X, the Y processing module 170Y, and the Z processing module 170Z) notifies the error state management module 110 of occurrence of the error. When, based on analysis of job data, a condition in the failure table 300 is satisfied, the image generation module 170A notifies the job management module 120 of “determination condition satisfied”.

In Step 104, when an error or the like occurs, the error state management module 110 notifies the job management module 120 of occurrence of the error. The job management module 120 determines, based on the failure table 300, whether or not an occurrence condition is satisfied. When the occurrence condition is satisfied, the job management module 120 sets a failure code/corrected version information as supplementary information of the error or the like. If an error occurs, printing is not completed normally. Therefore, even after job processing is performed, the job is not deleted from the job attribute management table 400. When output abnormality occurs (that is, when “a failure but not an error” occurs), a target image is exported.

In Step 106, information regarding the failure is displayed at the display module 130. As information regarding the failure, an avoidance measure/corrected version is presented. Then, a screen for an instruction for application of an avoidance measure/instruction for application of a corrected version is displayed.

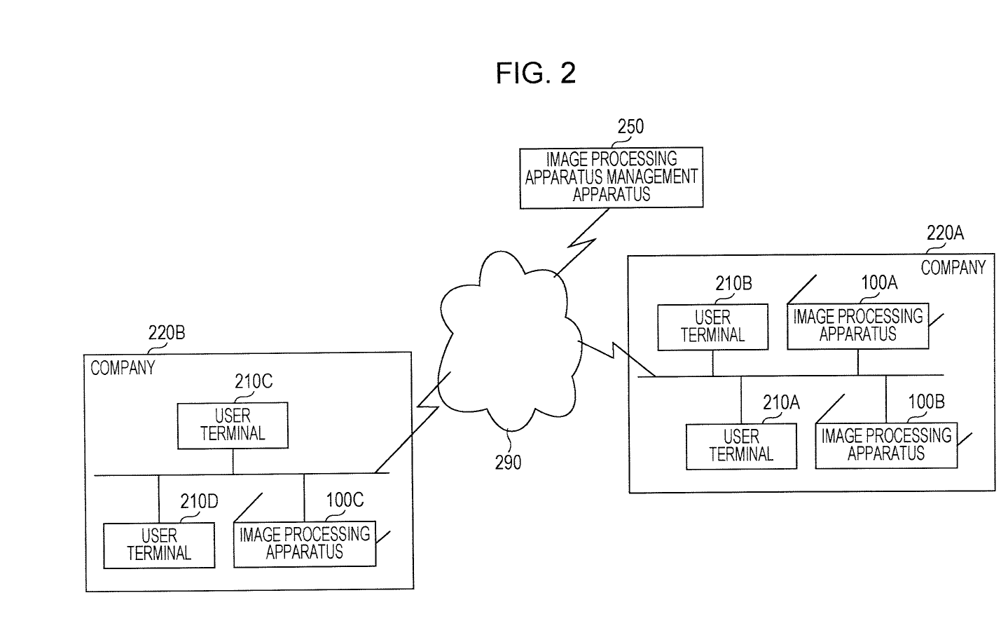

FIG. 2 is an explanatory diagram illustrating an example of a system configuration according to an exemplary embodiment.

An image processing apparatus 100A, an image processing apparatus 100B, a user terminal 210A, and a user terminal 210B are installed at a company 220A, and they are connected to one another.

An image processing apparatus 100C, a user terminal 210C, and a user terminal 210D are installed at a company 220B, and they are connected to one another.

The apparatuses within the company 220A, the apparatuses within the company 220B, and an image processing apparatus management apparatus 250 are connected to one another via a communication line 290. The communication line 290 may be a wireless line, a wired line, or a combination of wireless and wired lines. The communication line 290 may be, for example, the Internet, an intranet, or the like as a communication infrastructure.

The image processing apparatus management apparatus 250 updates the failure table 300 to be stored in the determination condition table storing module 140 of each of the image processing apparatuses 100. For example, the image processing apparatus management apparatus 250 may transmit the failure table 300 to each of the image processing apparatuses 100 every time that the failure table 300 is updated. Furthermore, when communication lines of the companies 220 are connected to the communication line 290 via a firewall, the image processing apparatus management apparatus 250 is not able to be connected directly to the image processing apparatus 100. However, when a connection request is issued from the image processing apparatus 100 to the image processing apparatus management apparatus 250 (may be a regular connection request or irregular connection request), data of the failure table 300 may be transmitted from the image processing apparatus management apparatus 250 to the image processing apparatus 100. Functions of the image processing apparatus management apparatus 250 may be implemented as cloud service.

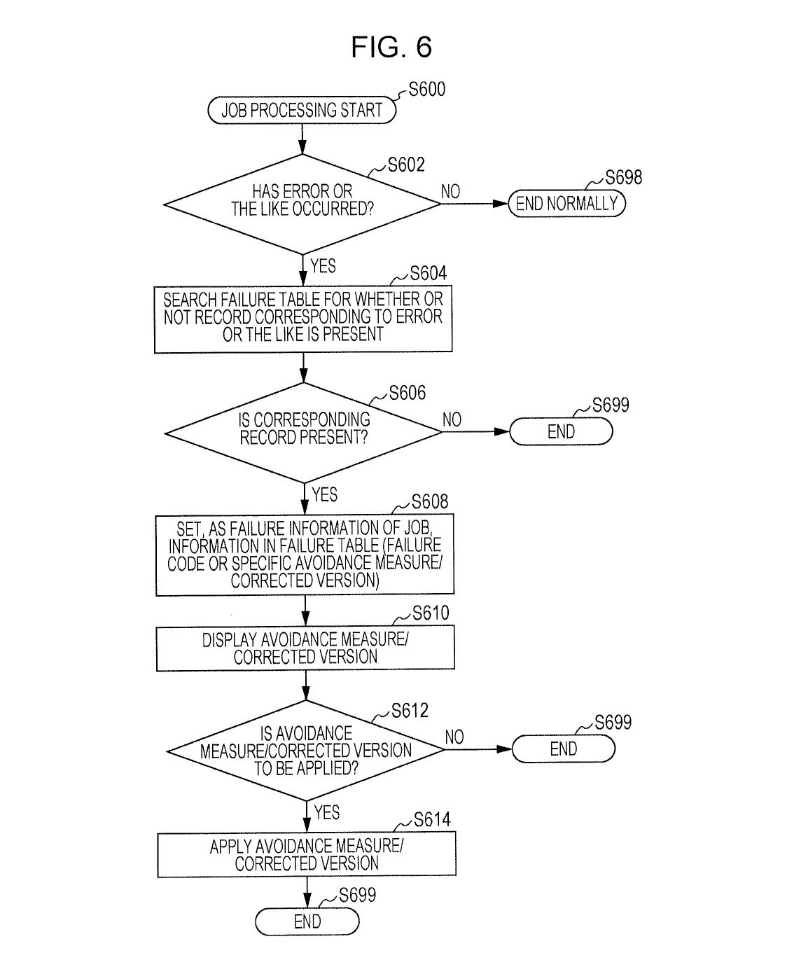

FIG. 6 is a flowchart illustrating a processing example according to the first exemplary embodiment.

In step S600, the corresponding image generation module 170A, the X processing module 170X, or the like starts job processing.

In step S602, it is determined whether or not an error or the like has occurred. When an error or the like has occurred, the process proceeds to step S604. When an error or the like has not occurred, the process ends normally (step S698).

In step S604, the failure table 300 is searched for a record which corresponds to the error or the like is present. As is clear from the definition provided above, an error may not correspond to a failure. Furthermore, it is clear that a failure which has been notified from the image generation module 170A is present in the failure table 300, the process may proceed to step S608.

In step S606, it is determined whether or not the corresponding record is present. When the corresponding record is present, the process proceeds to step S608. When the corresponding record is not present, the process ends (step S699).

In step S608, as failure information of the job, information of the failure table 300 (a failure code or a specific avoidance measure/corrected version) is set.

In step S610, the avoidance measure/corrected version is displayed.

In step S612, in accordance with an instruction by an operator, it is determined whether or not the avoidance measure/corrected version is to be applied. When the avoidance measure/corrected version is to be applied, the process proceeds to step S614. When the avoidance measure/corrected version is not to be applied, the process ends (step S699).

In step S614, the avoidance/measure corrected version is applied.

### Second Exemplary Embodiment

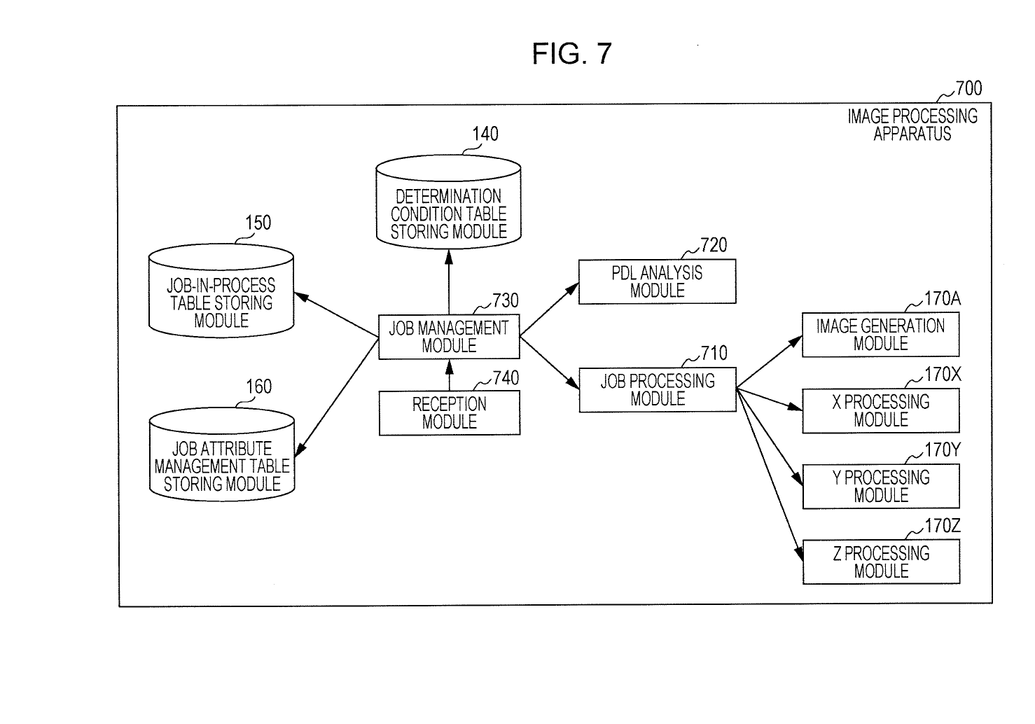

FIG. 7 is a conceptual module configuration diagram of a configuration example according to a second exemplary embodiment.

An image processing apparatus 700 includes a job processing module 710, a PDL analysis module 720, a job management module 730, a reception module 740, a determination condition table storing module 140, a job-in-process table storing module 150, a job attribute management table storing module 160, an image generation module 170A, an X processing module 170X, a Y processing module 170Y, and a Z processing module 170Z. Parts of the same types as those in the foregoing exemplary embodiment will be referred to with the same signs and redundant explanation will be omitted (the same applies to the below).

The image generation module 170A is connected to the job processing module 710. The X processing module 170X is connected to the job processing module 710. The Y processing module 170Y is connected to the job processing module 710. The Z processing module 170Z is connected to the job processing module 710.

The job processing module 710 is connected to the job management module 730, the image generation module 170A, the X processing module 170X, the Y processing module 170Y, and the Z processing module 170Z. The job processing module 710 causes the image generation module 170A, the X processing module 170X, and so on to perform job processing under the control by the job management module 730.

The PDL analysis module 720 is connected to the job management module 730. The PDL analysis module 720 analyzes PDL contents as job data, which is a target of the image generation module 170A. Specifically, the PDL analysis module 720 analyzes whether or not job data corresponding to the job data field 330 in the failure table 300 exists in the PDL.

The determination condition table storing module 140 is connected to the job management module 730. The determination condition table storing module 140 further stores a processing order or states of other processing for the case where a failure occurs as a failure occurrence condition, as well as the information stored in the determination condition table storing module 140 according to the first exemplary embodiment.

The job management module 730 is connected to the job processing module 710, the PDL analysis module 720, the reception module 740, the determination condition table storing module 140, the job-in-process table storing module 150, and the job attribute management table storing module 160. For starting processing of a job, when a failure occurrence condition in the determination condition table storing module 140 is satisfied, the job management module 730 controls the job processing module 710 to stop the processing until the occurrence condition becomes unsatisfied. Alternatively, the job management module 730 controls the job processing module 710 to change the processing order. Stopping the processing and changing the processing order are not necessarily presented. As a failure occurrence condition, specifically, it is determined whether or not conditions in the state field 325 and the sequence field 340 of the failure table 300 are satisfied.

By separately providing an image processing/image generation program and a program for controlling the order, only the program for controlling the order may be updated. A user may emphasize the operation history of an image processing/image generation program and use an old version of the image processing/image generation program. However, the program for controlling the job order, which is not directly relevant to image processing/image generation, is often updated. Therefore, avoidance may be provided (without presentation) to the user who maintains the old version.

The job-in-process table storing module 150 is connected to the job management module 730. The job attribute management table storing module 160 is connected to the job management module 730.

The overview of a process of the image processing apparatus 700 will be described below.

In Step 702, for starting job processing, the job management module 730 performs, based on the current job state in the job-in-process table storing module 150 and a result of the PDL analysis module 720, determination processing as to whether or not an occurrence condition in the determination condition table storing module 140 is satisfied. When it is determined that a failure is to occur, a job starts when a sequence that may be processed (a state in which a failure has been removed) is reached. For example, in the case where the state corresponds to “an image is being generated at a different job” in a failure code: 1 in the failure table 300 illustrated in the example of FIG. 3, after “image generation at different job” is completed, processing for the target job is performed. That is, the image generation module 170A causes processing to be performed in order without concurrent processing in which a failure occurs being performed. In addition to this, when “three image generation processes are performed concurrently” is set in the sequence field 340 of the failure table 300, if three image generation processes are to be performed concurrently at a new job, after the image generation process that is currently being performed is completed, processing for the target job is performed. Furthermore, as described above by way of example of concurrent image generation processes, it is obvious that a sequence at the X processing module 170X and the like and a combination of different processes may be set as conditions.

In Step 704, during the job processing, a sequence is not made improper even if a new job is received from the reception module 740. Specifically, processing for not starting processing for a received job but starting the processing when a certain state (a state where a failure has been removed) is reached is performed.

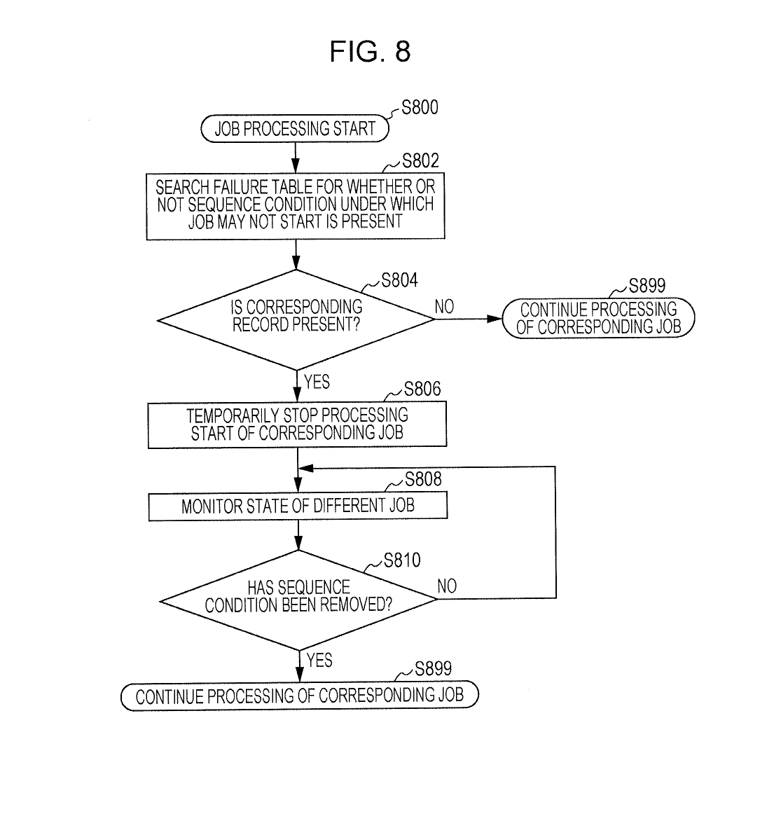

FIG. 8 is a flowchart illustrating a processing example according to the second exemplary embodiment.

In step S800, the corresponding image generation module 170A, the X processing module 170X, or the like starts job processing.

In step S802, the failure table 300 is searched for a sequence condition under which a job may not start.

In step S804, it is determined whether or not a corresponding record is present. When the corresponding record is present, the process proceeds to step S806. When the corresponding record is not present, the corresponding job processing continues to be performed (step S899).

In step S806, processing start of the job is temporarily stopped.

In step S808, the state of a different job is monitored. In step S810, it is determined whether or not the sequence condition has been removed. When the sequence condition has been removed, processing for the job continues to be performed (step S899). When the sequence condition has not been removed, the process returns to step S808.

### Third Exemplary Embodiment

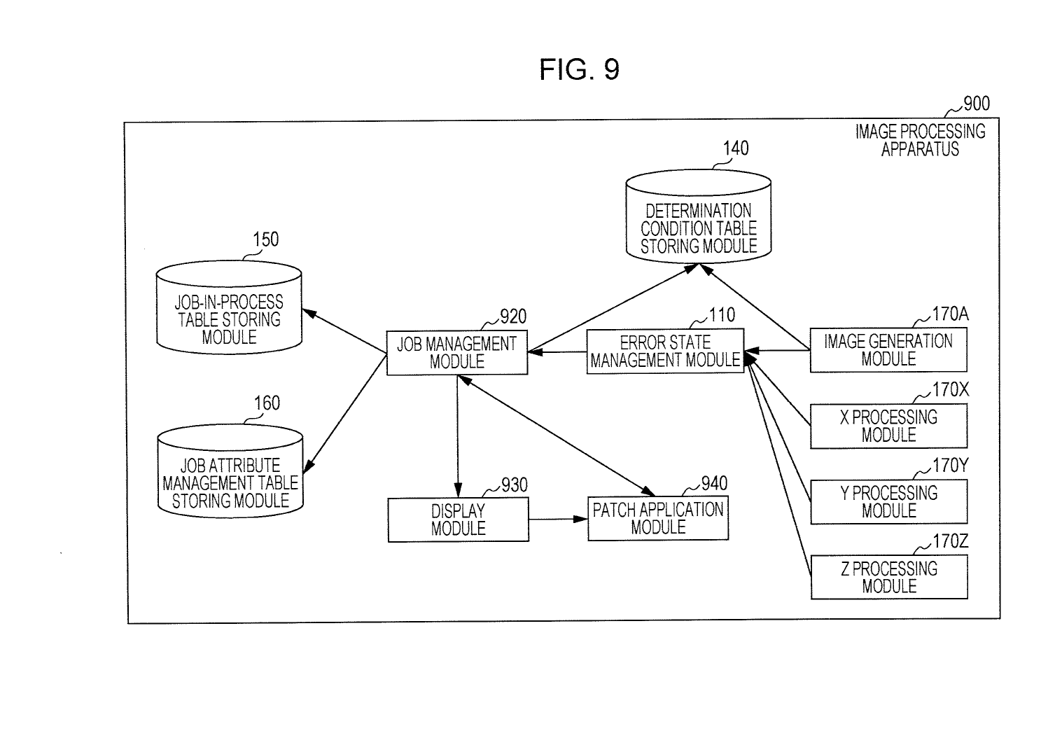

FIG. 9 is a conceptual module configuration diagram of a configuration example according to a third exemplary embodiment.

An image processing apparatus 900 includes an error state management module 110, a job management module 920, a display module 930, a patch application module 940, a determination condition table storing module 140, a job-in-process table storing module 150, a job attribute management table storing module 160, an image generation module 170A, an X processing module 170X, a Y processing module 170Y, and a Z processing module 170Z.

A user may be careful about updating by emphasizing the operation history and continue to use an old version even after a version in which a failure has been removed is released.

The image processing apparatus 900 provides a user who continues to use an old version with a function for confirming output after updating is performed.

The image generation module 170A is connected to the error state management module 110 and the determination condition table storing module 140. The X processing module 170X is connected to the error state management module 110. The Y processing module 170Y is connected to the error state management module 110. The Z processing module 170Z is connected to the error state management module 110.

The error state management module 110 is connected to the job management module 920, the image generation module 170A, the X processing module 170X, the Y processing module 170Y, and the Z processing module 170Z.

The job management module 920 is connected to the error state management module 110, the display module 930, the patch application module 940, the determination condition table storing module 140, the job-in-process table storing module 150, and the job attribute management table storing module 160. The job management module 920 further controls the patch application module 940 such that an image processing program of a version in which the failure that corresponds to an occurrence condition for a failure detected by the error state management module 110 has been removed is tentatively applied, in addition to the function of the job management module 120 according to the first exemplary embodiment. “Tentatively” corresponds to “so that a state before application is performed may be reobtained after the application is performed”.

The display module 930 is connected to the job management module 920 and the patch application module 940. The display module 930 further presents an instruction (for example, displaying an instruction button on a display) as to whether or not to tentatively apply a corrected version (an image processing program in which a failure has been removed), in addition to the function of the display module 130 according to the first exemplary embodiment. When an instruction for applying the corrected version is received, the display module 930 instructs the patch application module 940 to tentatively apply the corrected version. After the corrected version is tentatively applied, the display module 930 presents an instruction as to whether or not to fully apply the corrected version. When an instruction for fully applying the corrected version is received, the display module 930 instructs the patch application module 940 to fully apply the corrected version. When an instruction for not fully applying the corrected version is received, the display module 930 instructs the patch application module 940 to return to the previous state.

The patch application module 940 is connected to the job management module 920 and the display module 930. When an instruction for tentatively applying the corrected version is received from the display module 930, the patch application module 940 applies the corrected version in accordance with an instruction from the job management module 920. When an instruction for fully applying the corrected version is received from the display module 930, the patch application module 940 fully applies the corrected version. Furthermore, when an instruction for returning to the previous state is received from the display module 930, the patch application module 940 deletes the corrected version and returns to the previous state.

The determination condition table storing module 140 is connected to the job management module 920 and the image generation module 170A. The job-in-process table storing module 150 is connected to the job management module 920. The job attribute management table storing module 160 is connected to the job management module 920.

The overview of a process of the image processing apparatus 900 will be described.

In Step 902, when an error occurs, each of the processing modules (the image generation module 170A, the X processing module 170X, the Y processing module 170Y, and the Z processing module 170Z) notifies the error state management module 110 of occurrence of the error. When a condition in the failure table 300 is satisfied based on an analysis result of job data, the image generation module 170A notifies the job management module 920 of the error as “determination condition satisfied”.

In Step 904, when an error occurs, the error state management module 110 notifies the job management module 920 of the error. The job management module 920 determines, based on the failure table 300, whether or not an occurrence condition is satisfied. When the occurrence condition is satisfied, the job management module 920 sets a failure code/corrected version information as supplementary information of the error. If an error occurs, printing is not completed normally. Therefore, even after job processing is performed, the job is not deleted from the job attribute management table 400. When output abnormality occurs (that is, when “a failure but not an error” occurs), a target image is exported.

In Step 906, information regarding the failure is displayed at the display module 930. As information regarding the failure, an avoidance measure/corrected version is presented. A screen for an instruction for applying an avoidance measure/applying a corrected version is displayed.

In Step 908, when the instruction for applying the avoidance measure is received, the display module 930 notifies the patch application module 940 of tentative application of a correction patch.

In Step 910, the patch application module 940 notifies the job management module 920 of pre-processing for tentative application of the correction patch (printing before application, collection of an image, storing of a state before tentative application is performed, or the like).

In Step 912, after the pre-processing for tentative application of the correction patch at the job management module 920 is completed, application of the correction patch is performed. After the correction patch is tentatively applied, the corresponding job is processed again. A user makes a comparison between a result after the correction patch is applied and a result before the correction patch is applied (result of processing before tentative application of the correction patch), and determines whether or not to perform full application (updating). A result obtained by comparing the image exported in Step 904 with an image after tentative application is performed (for example, EOR processing or the like) may be output.

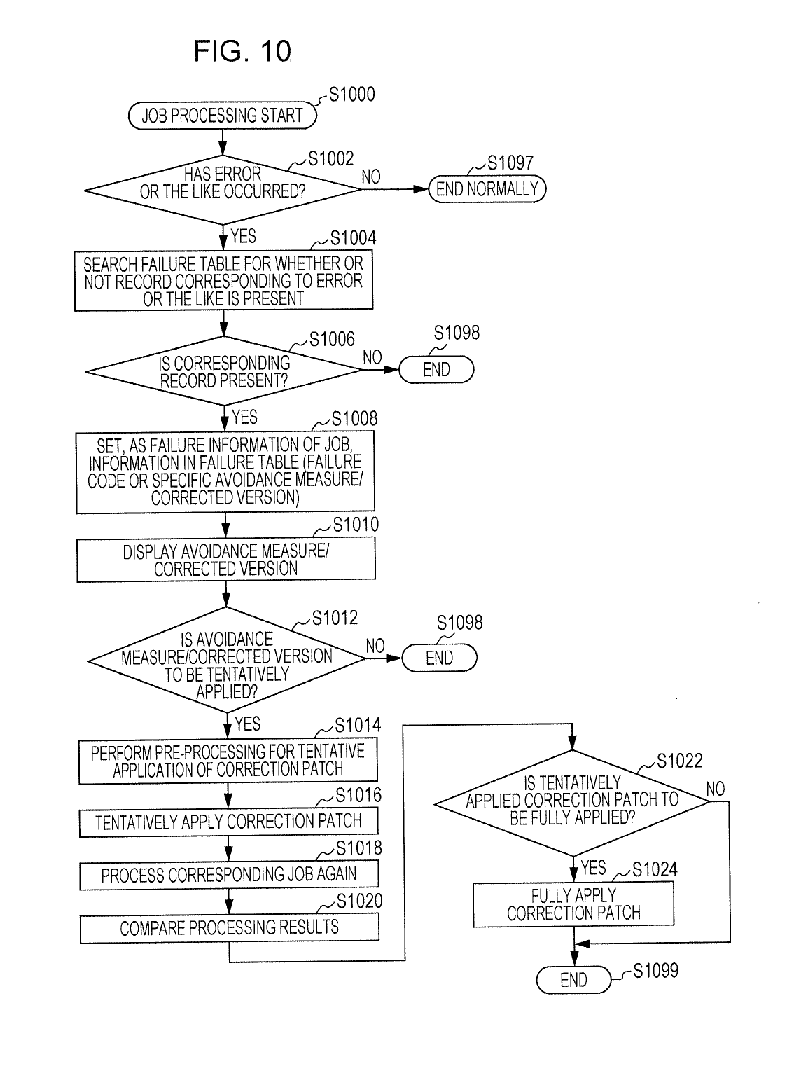

FIG. 10 is a flowchart illustrating a processing example according to the third exemplary embodiment.

In step S1000, the corresponding image generation module 170A, the X processing module 170X, or the like starts job processing.

In step S1002, it is determined whether or not an error or the like has occurred. When an error or the like has occurred, the process proceeds to step S1004. When an error or the like has not occurred, the process ends normally (step S1097).

In step S1004, the failure table 300 is searched for a record corresponding to the error or the like is present.

In step S1006, it is determined whether or not the corresponding record is present. When the corresponding record is present, the process proceeds to step S1008. When the corresponding record is not present, the process ends (step S1098).

In step S1008, as failure information of the job, information (a failure code or a specific avoidance measure/corrected version) in the failure table 300 is set.

In step S1010, the avoidance measure/corrected version is displayed.

In step S1012, it is determined, in accordance with an operation by an operator, whether or not the avoidance measure/corrected version is to be tentatively applied. When the avoidance measure/corrected version is to be tentatively applied, the process proceeds to step S1014. When the avoidance measure/corrected version is not to be tentatively applied, the process ends (step S1098).

In step S1014, pre-processing for tentative application of a correction patch is performed. Pre-processing includes, for example, printing before application, collection of an image, storing of a state before tentative application is performed, and the like.

In step S1016, the correction patch is tentatively applied.

In step S1018, the corresponding job is processed again. In step S1020, a comparison between processing results is made.

In step S1022, it is determined, in accordance with an operation by an operator, whether or not the tentatively applied correction patch is to be fully applied. When the correction patch is to be fully applied, the process proceeds to step S1024. When the correction patch is not to be fully applied, the process ends (step S1099). For the case where the correction patch is not to be fully applied, processing for returning to a state before the correction patch is tentatively applied is performed.

In step S1024, the correction patch is fully applied.

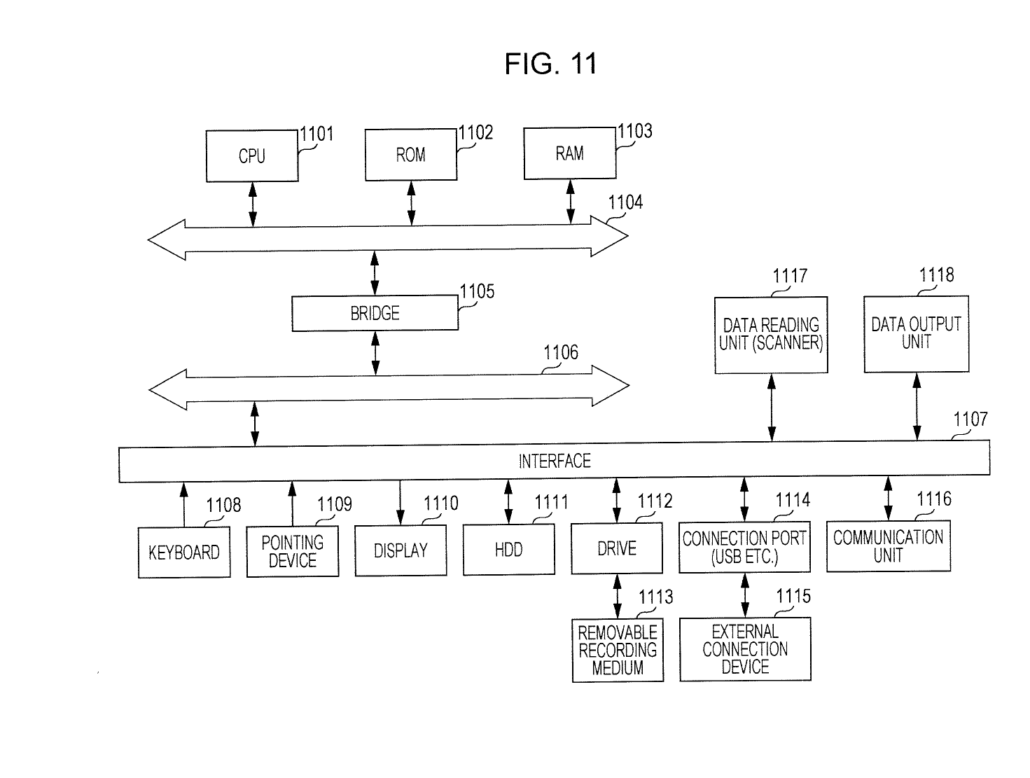

An example of a hardware configuration of an image processing apparatus according to an exemplary embodiment will be described with reference to FIG. 11. The configuration illustrated in FIG. 11 includes, for example, a personal computer (PC) or the like, and illustrates an example of a hardware configuration including a data reading unit 1117 such as a scanner and a data output unit 1118 such as a printer.

A CPU 1101 is a controller which performs processing in accordance with a computer program describing an execution sequence of the various modules described in the foregoing exemplary embodiments, that is, the error state management module 110, the job management module 120, the display module 130, the image generation module 170A, the X processing module 170X, the Y processing module 170Y, the Z processing module 170Z, the job processing module 710, the PDL analysis module 720, the job management module 730, the reception module 740, the job management module 920, the display module 930, the patch application module 940, and the like.

A read only memory (ROM) 1102 stores a program, an arithmetic parameter, and the like to be used by the CPU 1101. A RAM 1103 stores a program to be used for execution of the CPU 1101, a parameter which appropriately varies in the execution of the CPU 1101, and the like. The CPU 1101, the ROM 1102, and the RAM 1103 are connected to one another by a host bus 1104 which includes a CPU bus or the like.

The host bus 1101 is connected to an external bus 1106 such as a peripheral component interconnect/interface (PCI) bus via a bridge 1105.

A keyboard 1108 and a pointing device 1109 such as a mouse are devices to be operated by an operator. A display 1110 may be a liquid crystal device, a cathode ray tube (CRT), or the like, and displays various types information as text or image information.

A hard disk drive (HDD) 1111 includes therein a hard disk (may be a flash memory or the like). The HDD 1111 drives the hard disk to record or reproduce a program to be executed by the CPU 1101 and information. The hard disk implements functions as the determination condition table storing module 140, the job-in-process table storing module 150, the job attribute management table storing module 160, and the like. Other various data, various computer programs, and the like are also stored in the hard disk.

A drive 1112 reads data or a program recorded in an inserted removable recording medium 1113 such as a magnetic disk, an optical disc, a magneto-optical disk, or a semiconductor memory, and supplies the data or program to the RAM 1103 which is connected via an interface 1107, the external bus 1106, the bridge 1105, and the host bus 1104. The removable recording medium 1113 may also be used as a data recording region.

A connection port 1114 is a port which allows connection with an external connection device 1115, and has a connection part for a universal serial bus (USB), IEEE 1394, or the like. The connection port 1114 is connected to the CPU 1101 and the like via the interface 1107, the external bus 1106, the bridge 1105, the host bus 1104, and the like. A communication unit 1116 is connected to a communication line, and performs data communication processing with an external device. The data reading unit 1117 is, for example, a scanner, and performs document reading processing. The data output unit 1118 is, for example, a printer, and performs document data output processing.

The hardware configuration of the image processing apparatus illustrated in FIG. 11 illustrates a configuration example. An exemplary embodiment is not limited to the configuration illustrated in FIG. 11 as long as a configuration which may execute modules explained in the exemplary embodiment is provided. For example, part or all of the modules may be configured as dedicated hardware (for example, an application specific integrated circuit (ASIC) or the like), part or all of the modules may be arranged in an external system in such a manner that they are connected via a communication line, or the system illustrated in FIG. 11 which is provided in plural may be connected via a communication line in such a manner that they operate in cooperation. Furthermore, in particular, part or all of the modules may be incorporated in a personal computer, a portable information communication device (including a mobile phone, a smart phone, a mobile device, and a wearable computer), an information electronic appliance, a robot, a copying machine, a facsimile machine, a scanner, a printer, or a multifunction device.

The foregoing various exemplary embodiments may be combined together (for example, including adding a module in an exemplary embodiment to a different exemplary embodiment and replacing a module in an exemplary embodiment with a module in a different exemplary embodiment), and a technique described in related art may be adopted as processing details of individual modules.

Furthermore, any (or all) of the image generation module 170A, the X processing module 170X, the Y processing module 170Y, and the Z processing module 170Z may have the same configuration as the error state management module 110 and the job management module 120, in terms of hardware. For example, they may perform different processes by causing different programs (for example, a program of the image generation module 170A and a program of the error state management module 110) to operate at a single CPU.

The programs described above may be stored in a recording medium and provided or may be supplied through communication. In this case, for example, the program described above may be considered as an invention of “a computer-readable recording medium which records a program”.

“A computer-readable recording medium which records a program” represents a computer-readable recording medium which records a program to be used for installation, execution, and distribution of the program.

A recording medium is, for example, a digital versatile disc (DVD), including “a DVD-R, a DVD-RW, a DVD-RAM, etc.”, which are the standards set by a DVD forum, and “a DVD+R, a DVD+RW, etc.”, which are the standards set by a DVD+RW, a compact disc (CD), including a read-only memory (CD-ROM), a CD recordable (CD-R), a CD rewritable (CD-RW), etc., a Blu-ray™ Disc, a magneto-optical disk (MO), a flexible disk (FD), a magnetic tape, a hard disk, a ROM, an electrically erasable programmable read-only memory (EEPROM™), a flash memory, a RAM, a secure digital (SD) memory card, or the like.

The entire or part of the above-mentioned program may be recorded in the above recording medium, to be stored and distributed. Furthermore, the program may be transmitted through communication, for example, a wired network or a wireless communication network used for a local area network (LAN), a metropolitan area network (MAN), a wide area network (WAN), the Internet, an intranet, an extranet, or the like, or a transmission medium of a combination of the above networks. Alternatively, the program or a part of the program may be delivered by carrier waves.

The above-mentioned program may be the entire or part of another program or may be recorded in a recording medium along with a separate program. Further, the program may be divided into multiple recording media and recorded. The program may be recorded in any format, such as compression or encryption, as long as the program may be reproduced.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a processing unit that processes a processing target of image processing in accordance with image processing setting for the processing target and an image processing program;
a storing unit that stores at least one occurrence condition for a failure at the processing unit;
a detecting unit that detects, in accordance with a detection program, whether or not the processing target or the setting satisfies the occurrence condition for the failure; and
a controller that performs control for presenting information for avoiding the failure or control for avoiding the failure when the detecting unit detects that the occurrence condition for the failure is satisfied.

2. The image processing apparatus according to claim 1,
wherein the image processing setting includes printing processing setting, and
wherein the occurrence condition is whether or not the printing processing is set to a specific setting.

3. The image processing apparatus according to claim 2, wherein the printing processing setting includes at least one of a color mode, setting of page layout, setting of a page number, description contents of PDL, description contents of PDF, a paper size, a processing system used for image generation, and color adjustment.

4. The image processing apparatus according to claim 1, wherein the information for avoiding the failure, the occurrence condition for the failure, or a method for avoiding the failure is presented.

5. The image processing apparatus according to claim 4,
wherein the storing unit stores a version of a program in which the failure has been removed, in association with the occurrence condition for the failure, and
wherein the method for avoiding the failure is implemented by presenting the version of the program in which the failure has been removed.

6. The image processing apparatus according to claim 1,
wherein the storing unit stores, as the occurrence condition for the failure, a processing order or a state of different processing for a case where the failure occurs, and
wherein as the control for avoiding the failure, for starting processing, when the occurrence condition for the failure is satisfied, the controller stops the processing until the occurrence condition becomes unsatisfied or changes the processing order.

7. The image processing apparatus according to claim 1,
wherein the storing unit stores a program of a version in which the failure has been removed, in association with the occurrence condition for the failure, and
wherein as the control for avoiding the failure, the controller performs control such that the program of the version in which the failure has been removed, which corresponds to the occurrence condition for the failure detected by the detecting unit, is tentatively applied.

8. An image processing system comprising:
an image processing apparatus that includes
a processing unit that processes a processing target of image processing in accordance with image processing setting for the processing target and an image processing program,
a storing unit that stores an occurrence condition for a failure at the processing unit,
a detecting unit that detects, in accordance with a detection program, whether or not the processing target or the setting satisfies the occurrence condition for the failure, and
a controller that performs control for presenting information for avoiding the failure or control for avoiding the failure when the detecting unit detects that the occurrence condition for the failure is satisfied; and
an update apparatus that includes
an update unit that updates a content of the storing unit, the update apparatus being connected to the image processing apparatus via a communication line.

9. An image processing method comprising:
processing a processing target of image processing in accordance with image processing setting for the processing target and an image processing program;
storing an occurrence condition for a failure;
detecting, in accordance with a detection program, whether or not the processing target or the setting satisfies the occurrence condition for the failure; and
performing control for presenting information for avoiding the failure or control for avoiding the failure when it is detected that the occurrence condition for the failure is satisfied.

10. A non-transitory computer readable medium storing a program causing a computer to execute a process for image processing, the process comprising:
processing a processing target of image processing in accordance with image processing setting for the processing target and an image processing program;
storing an occurrence condition for a failure;
detecting, in accordance with a detection program, whether or not the processing target or the setting satisfies the occurrence condition for the failure; and
performing control for presenting information for avoiding the failure or control for avoiding the failure when it is detected that the occurrence condition for the failure is satisfied.
